(19) United States
(12) Patent Application Publication
(10) Pub. No.: US 2013/0032001 A1
(43) Pub. Date: Feb. 7, 2013

(54) INTEGRATED REMOVABLE STORAGE AND HANDLEBAR SYSTEM

(71) Applicant: Simon Smart, Helmdon (GB)

(72) Inventor: Simon Smart, Helmdon (GB)

(21) Appl. No.: 13/198,700

(22) Filed: Aug. 4, 2011

(51) Int. Cl. B62K 21/12

(52) U.S. Cl. 74/551.8

(57) ABSTRACT

Embodiments described herein provide for an integrated hydration and nutrition container with or within the handlebars of a cycling system (e.g., a bicycle). Such integration allows a rider easy access to the nutritional value necessary for high performance competition with little to no movement required, thereby allowing the rider to maintain focus, balance, speed, and aerodynamic efficiency. In one embodiment, the system is easily removable, if desired; yet holds firmly in place (with also available airfoil adjustments) on the desired handlebar positioning during a ride. In another embodiment, the container resides within the handlebar unit itself.

### CROSS-REFERENCE TO RELATED APPLICATIONS

N/A

### BACKGROUND

Union Cycliste Internationale (UCI)—a.k.a. in English as the International Cycling Union—is the world governing body for sports cycling and oversees international competitive cycling events. Among its various duties, the UCI manages the classification of races and the points ranking system in various cycling disciplines including mountain biking, road and track cycling, for both men and women, amateur and professional. It also oversees the World Championships.

One of the more controversial roles of the UCI resides in the technical regulations it establishes and enforces with regard to the eligibility of bicycles used in the varying types of racing discipline. Although many feel that the rules arbitrarily restrict riders from achieving faster times, the UCI counters that strict adherence to these rules “guarantees sporting fairness and safety during competition.” As such, racers' bikes must conform to the standards set when wishing to compete in most any UCI sponsored event; and especially those in the three disciplines of: road events, track events and cyclo-cross. Each discipline has its own technical characteristics and each may have variants depending on the type of event.

For example, in massed-start road races and cyclo-cross, Article 1.3.020 of the UCI technical regulations states that the frame elements shall be tubular without excessive curvature (a straight line along the element's longitudinal axis must remain inside the element). Further, the regulations state that the elements shall have a maximum transverse dimension of 8 cm and a minimum transverse dimension of 2.5 cm (reduced to 1 cm for the seat stays, chain stays and forks).

The above max/min traverse dimensions are further limited to a “1:3 ratio”, which applies to the shapes of bicycle elements, with the exception of moving parts (wheels and chainsets1) and the saddle. Likewise, Article 1.3.024 establishes that aerodynamic assemblies and protuberances on the head tube are prohibited. More specifically, the Regulations do not allow for protective screens, aerodynamic shapes, fairings or any other device added or forming part of the structure, which is destined or has the effect of reducing wind resistance. Nevertheless, this regulation does not apply to the pedals, front or rear derailleur bodies or wheel brake mechanisms. The regulation does, however, apply to all elements making up the frame architecture as well as frame accessories (stem, handlebars, handlebar extension, seat post).

Notwithstanding any of the above, the subject of the shape of bicycle elements (1:3 ratio) does not exempt manufacturers from complying with the official “racing bicycle” standards when concerning uncovered projections, which, e.g., must be rounded for safety. Further, the 1:3 ratio does not limit other items including: brake levers, gear levers, bottle cages and other items; however, such elements with “knife-edge profile” shapes are not allowed.

To illustrate Regulation 1.3.024 (1:3 ratio), when using the maximum transverse dimension authorized for an element, namely 8 cm, the associated minimum transverse dimension is 8/3=2.66 cm. Likewise, when using the minimum transverse dimension authorized for an element, namely 2.5 cm, the associated maximum transverse dimension is 2.5×3=7.50 cm. For all intermediate options, the maximum to minimum transverse dimension ratio cannot exceed three.

Except for individual and team pursuit (kilometer and 500 time trials), only the traditional type of handlebars are authorized for use in massed-start road races, cyclo-cross and track competitions (under Article 1.3.022). Further, additional handlebar components or extension attachments are prohibited.

In contrast, for time trials on the road and track competitions the elements making up the frame are not restricted provided they fit freely inside a defined template (see regulations) and comply with the 1:3 ratio described above. (See comments on Article 1.3.021 and Article 1.3.020). Further, the bicycles may be fitted with an “additional handlebar” (extension) upon which elbow or forearm rests are authorized without these representing supplementary points of support (in contradiction of Regulation 1.3.008). The extension, as the name indicates, extends the handlebars in the horizontal plane and needs to be fitted with handgrips, which may be located on the handlebar extension horizontally, inclined or vertically. Nevertheless, the profile of the extension must conform to the 1:3 ratio in accordance with Article 1.3.024. Further, the extension must be fixed and not feature a system that would allow a change of length or angle during the race.

Although the use of handlebar extensions puts the rider in a more aerodynamic position for the road and track competitions, such position has unintended consequences. For example, because the rider's arms remain tightly held under the chest of the rider and slightly extended in a somewhat “superman” position, it becomes difficult for the rider to change this position or take her hands off the handle bar section without creating unwanted drag. Accordingly, when the rider needs water or other nutritional fuels during a race, the rider must shift their weight in order to reach for a bottle in a rack typically below their seat. Such shifting and reaching not only adds unwanted drag from the body's position, but may also cause a change in balance on the bike, resulting in stability issues. Further, because one must typically look in the direction of the water bottle to reach for it, the rider's attention is drawn away from the race and obstacles on the course—obviously increasing the risk for a serious accident due to any number of changed circumstances or unexpected events that require the rider's immediate attention. Although the odds of such unforeseen accident are low when a rider tries t reach for such items, even the most skilled rider will (at a minimum) experience a reduction in speed due to: (i) unwanted drag from change in optimal aerodynamic body position or angle; and (ii) decrease in pedaling momentum due to, e.g., lack in focus from sight diversion and/or changed bicycle stability from body movement.

Due to these inherent problems of current bicycle water bottle systems, there remains a need for a hydration and/or nutritional system that allows a rider to easily obtain the needed fuel with minimal movement and distraction. As an added consideration, the system should preferably improve aerodynamic performance; however, if necessary, it can still comply with the 1:3 ratio and other international bicycling regulations as outlined above by the UCI and other similar regulatory agencies.

### BRIEF SUMMARY

Example embodiments of the present invention overcome the above-identified deficiencies and drawbacks of current bicycle hydration and nutrition systems. For example, embodiments described herein provide for an integrated hydration and nutrition container with the handlebars of a cycling system (e.g., a bicycle). Such integration allows a rider easy access to the nutritional value necessary for high performance competition with little to no movement required, thereby allowing the rider to maintain focus, balance, speed, aerodynamic efficiency. Further, embodiments provide for an aerodynamic hydration and nutritional center, which although integrated with the handlebars of a bicycle may conform to the international regulatory schemes, but can also be easily removed with, and if, the regulating authority does not allow such systems. Typically, the system is easily removable, if desired; yet holds firmly in place on the desired handlebar positioning during a ride.

Note that this Summary simply introduces a selection of concepts in a simplified form that are further described below in the Detailed Description. Accordingly, this Summary does not necessarily identify key features or essential aspects of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantageous features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an integrated handlebar and hydration/nutrition containment system with a suction tub used for ease in extracting the contents of the unit in accordance with example embodiments of the present invention;

FIG. 2 illustrates a top view of a extended handlebar system with a water/food container attached thereto and a alternative content access mechanism in accordance with other example embodiments described herein;

FIG. 3 is a side or front directional view of an integrated water/food storage unit and handlebar system in accordance with example embodiments described herein;

FIGS. 4-7 illustrate various views of example storage containment units, there attachment mechanisms, and international regulatory compliance considerations in accordance with varying exemplary embodiments described herein;

FIG. 10 illustrates an alternative attachment and design consideration of the handlebar storage containment system and content extraction system in accordance with other example embodiments described herein;

FIGS. 11 and 12 illustrate top and front views, respectively, of a varying design for a integrated handlebar containment unit in accordance with example embodiments of he present invention;

FIG. 13 illustrates an alternative handlebar system that can also utilize the integrated containment system as described in example embodiments herein;

FIG. 14 illustrates a integrated handlebar and containment unit that does not comply with a 3:1 ratio according the UCI standards, but still includes other advantageous aerodynamic and other properties described herein and in accordance with example embodiments;

In contrast, FIG. 15 illustrates a hydration/nutritional supplement container, which complies with the 3:1 ratio; yet still has added aerodynamic and other advantageous features described herein according to exemplary embodiments; and

FIG. 16 illustrates a fully integrated arm rest system, fuel container, and handlebars in accordance with exemplary embodiments described herein.

### DETAILED DESCRIPTION

The present invention extends to methods, systems, and devices for a removable, yet integrated, storage container for a bicycle handlebar system. The storage container can hold most anything; however, embodiments generally consider its use as a water bottle, feed system, nutritional supplement, or other fuel resource holder. Although the following embodiments generally refer to the storage container as a water bottle or nutritional supplement storage container, any specific use of the contents of the storage container are used herein for illustrative purposes only and are not meant to limit or otherwise narrow the scope of the present invention unless otherwise explicitly claimed.

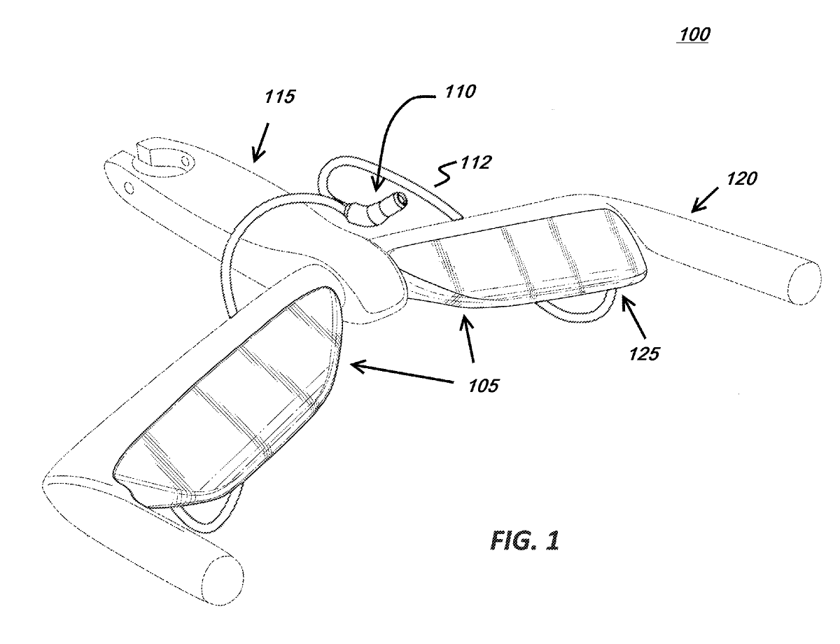

Turning now to the various Figures, e.g., as shown in FIG. 1, example embodiments provide for a handlebar 120 configured to accept an improved handlebar section that provides an integrated, removable bicycle handlebar storage container system 100, with storage unit(s) 105 for holding various items needed during a bicycle ride. As noted above, the storage unit(s) may hold any number of items, but typically hold water or fuel for human consumption. As such, in accordance with one example embodiment, the storage system 100 further includes a content extraction mechanism 112, which connects to the storage unit(s) for ease in consuming the contents of the container(s) 105 with little or no movement.

For example, as shown in FIG. 1, the extraction mechanism, may be a suction device such as a straw for sucking out the contents of the container(s) without the need for removal of the unit(s) from the bars themselves. Such suction unit may take the form of a straw or other plastic item. The item may be connected in any number of desired ways for proper ease in extracting the substance from the containment unit(s) 105. For instance, the suction tube 112 may be connected to the bottom 125 of the storage device 105, as shown in FIG. 1. In such case, the tubing 112 will need to be securely fastened to the under portion 125 of the unit(s) 105 with leak proof seals as needed. Of course, there may be any number of places to connect such extraction mechanisms. For instance, the suction unit 125 may be included through the top of the units, similar to putting a straw in a lid of a drink. Alternatively, or in combination, the extraction unit or tubing 112 may be connected through the side of the bottle or units 105 with appropriate extensions there from, thus allowing a rider to consume the contents of the container(s) 105 while remaining in the desired aerodynamic position on the bicycle.

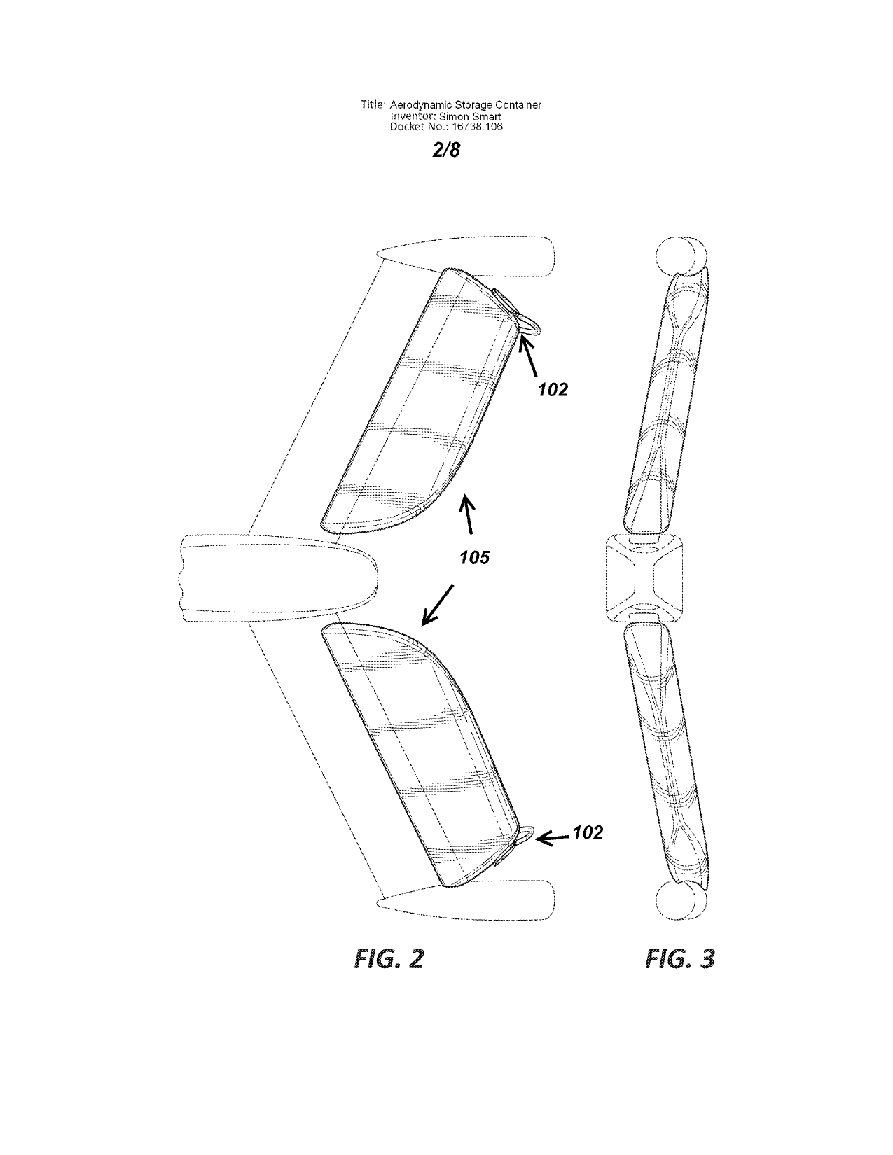

Of course, other example embodiments contemplate that the storage container or unit 105 may be accessed through alternative mechanisms. For example, as shown in FIG. 2, the bottles 105 may include caps or lids 102 as a mechanism for accessing the contents of the containers 105. Such lids may be any type of well known lid that attaches to the bottle 105 and seals the contents therein. For example, lids 102 may be snap on caps, screw caps, plug caps, or any other type of lid for securing the contents from inadvertent or unintentional leakage. In any event, the caps 102 will typically be of a form that provides easy access to the contents of the container 105 to ensure that the rider's discretion from her performance is minimal. Further, the lid will typically include some type of attachment mechanism to the bottle in order to not loose it when opening it on a ride.

Of course, other types of access mechanisms other than caps or straws are also contemplated herein. For instance, the access mechanism may be in the form of a lid for accessing contents of the container 105 other than liquid contents. For example, not shown in the current Figures, example embodiments consider that a lid may be formed in the top of the containers that flip open to allow one to get fuel or food supplements or any other items that one might wish to carry on a ride. In fact, example embodiments further contemplate a combination of access mechanisms. For example, as described in greater detail below, when the storage container resides internally within the handlebars, a combination of lid and suction member may be needed for access. For instance, the lid may allow access to a bladder that holds the contents of the actual container, and the suction device further provides a mechanism for easy extraction while operating the cycling unit. Accordingly, any specific type of lid or access mechanism for extracting the storage container or its contents as described herein is for illustrative purposes only and is not meant to limit or otherwise narrow the scope of the present invention unless otherwise specifically claimed.

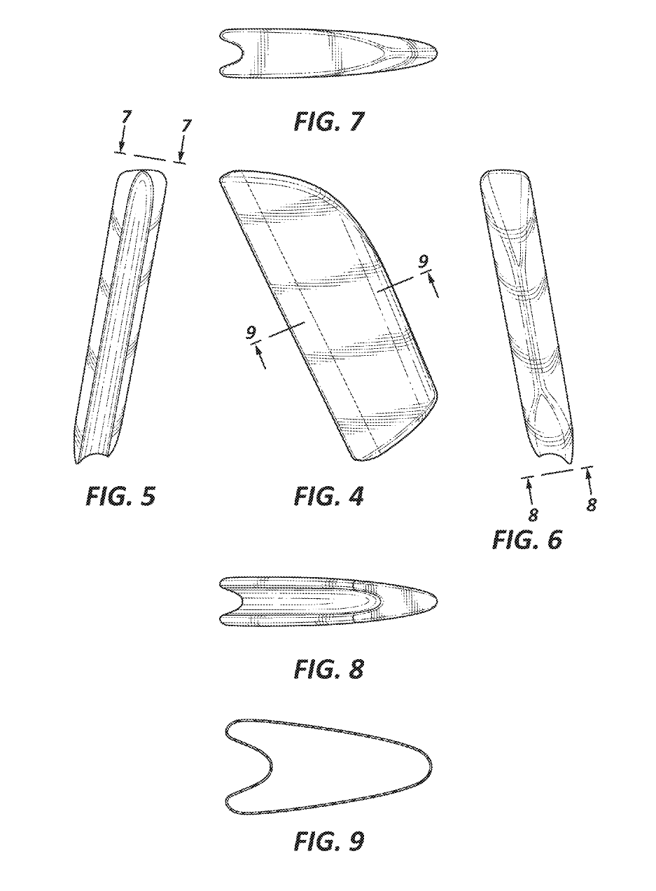

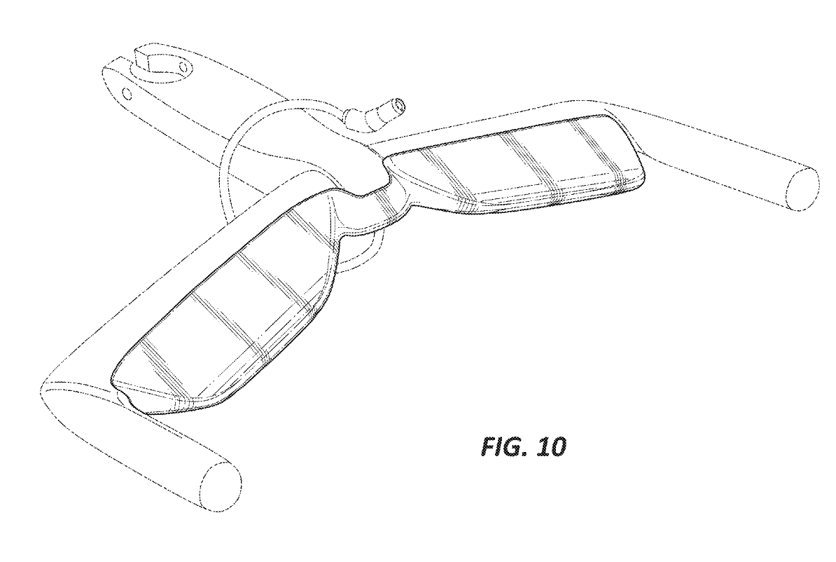

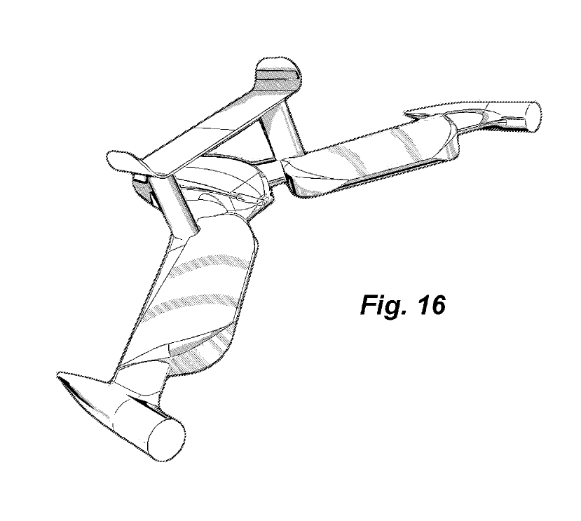

FIG. 3 illustrates the potential aerodynamic features of the storage container 105 in accordance with other example embodiments. As previously noted, one advantageous feature of one embodiment is the ability to extend the handlebar shape to a more aerodynamic shape; yet still remain in compliance with UCI and other regulatory authorities. For example, as shown in FIGS. 4-9, 14 and 15, the shape of the bottle (especially when combined with the bars) may be of a toroidal shape to form a substantially elliptical cross section. Generally, the forward facing part of the container 105 will form a narrow part of the ellipsis, gradually increasing in depth to a width diameter or distance (e.g., the distance formed by the lines 7 or 8 in FIGS. 5 and 6, respectively, or the width D or C shown in FIGS. 14 and 15, respectively), which will typically be larger than the widest part of the handlebars (see, e.g., FIG. 9, which shows a cusp) for forming fitting around the handlebar 120 itself and providing an aerodynamic flow of air or airfoil shape around therein. Of course, other types of shapes are also contemplated herein.

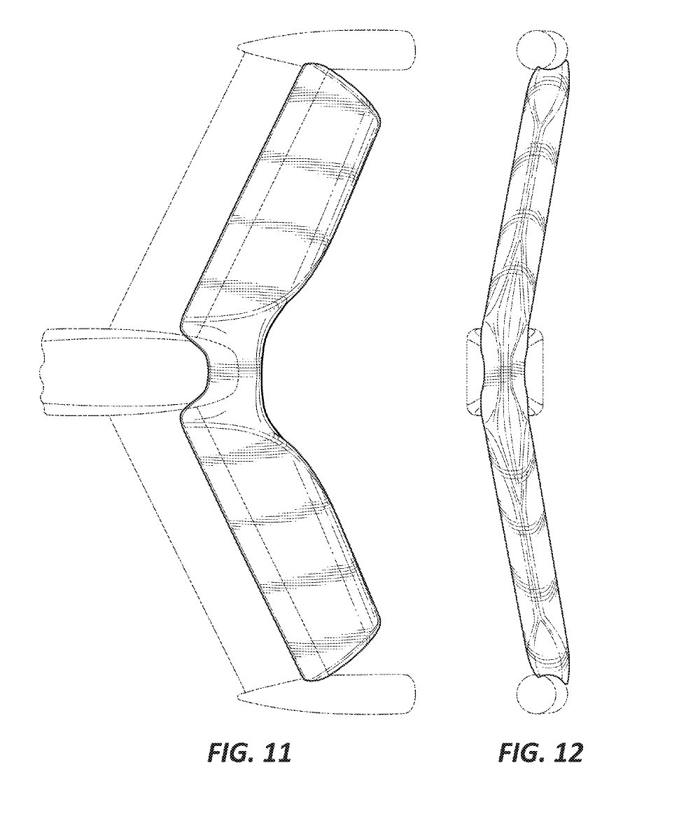

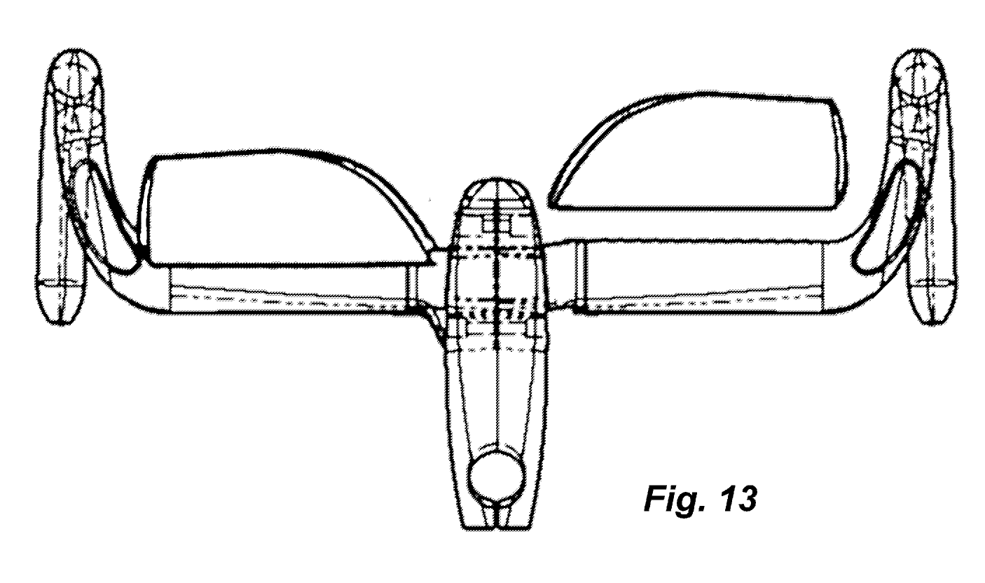

For example, the front of the bottle or container may be more rounded, e.g., as shown for example in FIG. 15, than narrowly tapered one shown in, e.g., FIG. 6. Further, the front of the bottle may vary or change in form, especially as it may form around other sections or parts of the handlebars 120 system. For instance, as illustrate in FIGS. 10, 11, 12, the containment unit 105 may form as a single piece formed around the several parts of a bicycle steering section, e.g., the handlebars 120 and gooseneck as shown in these figures. Moreover, the shape, style, and width of the various portions may vary across the length of the containers 105 depending on the desired airflow and form fitting needs when integrated into the handlebar 120 system. Although not preferred (or shown in the diagrams), the front of the bottle can even take on a blunt or square shape or form. In fact, in one embodiment, the shape of the storage container resembles that of typical water bottles. Although this may not gain the advantage of the desired aerodynamic features described herein, it does allow the rider to still easily consume the content with little movement from the riding position. In other words, example embodiments contemplate most any shape, style, form or number of sections for a storage container 105 as integrated into a handlebar 120 system; and therefore, any specific shape, style, form or number as described herein is for illustrative purposes only and is not meant to limit or otherwise narrow the scope of the present invention unless otherwise specifically claimed.

As previously noted, regardless of the shape, style, form or number of the storage container 105 units, the container(s) 105 will generally form an integral part of the handlebar 120 system. As such, example embodiments contemplate an aspect ratio (i.e., width to length diameter) of the integrated container 105 and handlebars 120 to range from about 2:1 to 6:1—and preferably about 3:1 or 3 in order to comply with UCI standards. As noted, however, the integrated storage containment 105 and handlebar 120 system may take on other aspect ratios and should not be limited to those noted above unless otherwise specifically claimed.

For example, FIGS. 14 and 15 illustrate two cross sectional views of integrated storage containment unit(s) 105 and handlebar 120 system in accordance with two varying example embodiments. As shown in FIG. 14, the aspect ratio of the width to length of the integrated system (i.e., storage unit 105 with the handlebars 120) may be non-UCI compliant (i.e., larger than 3:1 or 3). On the other hand, as shown in FIG. 15, the aspect ratio of the integrated storage containment unit 105 with the handlebar system 120 may preferably comply with UCI regulations, i.e., be less than about 3. Further, while not wishing to be bound by theory, it is believed that good aerodynamic efficiency is achieved with the integrated storage container 104 and the handlebar system by countervailing aerodynamic factors of minimum frontal area and laminar or smooth airflow are balanced.

In fact, other example embodiments further contemplate other aerodynamic enhancements the overall integrated storage containment and handlebar system described herein. For example, the handlebars 120 may be specifically designed for the storage containment unit 105 and or vise versa. As such, the system will form a tightly integrated feature with optimal aerodynamic properties. Further, this also allows for tighter control and optimization of the overall integrated structure with varying considerations such as: the desired ratio of the width to length in order to meet UCI and other requirements; the amount of storage space in the container; the rigidity of the handlebars; optimal aerodynamic properties of the combination; etc.

As mentioned above, one example embodiment contemplates the incorporation of the storage unit 105 directly into the handlebar unit 120. In this embodiment, the storage unit may comprise a bladder of sorts made from a malleable material such as rubber, plastic, cloth, animal or other organic material, or any combination thereof. The contents of the storage unit 105 may further be accessed by any well know mechanism such previously described such as a zip-lock sealer, zipper, cap, suction device, etc. On the other hand, accessing the storage unit within the handlebar section 120 may be done by a flap or door within the handlebar unit, or through access by one of the ends of the handlebars. Alternatively, the storage container 105 might be accessed through a sliding section of the bar that reveals the storage container therein. Of course, many other well know ways of incorporating a storage device within a generally solid unit are contemplated herein and the above gives merely some examples of mechanisms used in accessing the storage container and its contents when integrated internally within a handlebar system. For example, the storage unit may not necessarily have a separate bladder part as described above, but simply be formed within the handlebar section. As such, the above description of the storage unit internally formed within the handlebar system and the mechanisms for accessing such is used for illustrative purposes only and is not meant to limit or otherwise narrow the scope of the present invention unless otherwise explicitly claimed.

Further, other embodiments compensate or reduce the appearance of the discontinuity formed between the storage containment unit 105 and the handlebar 120 section by using aerodynamic trip edges or cusps formed in the container unit, handlebars system, or both. A correctly shaped trip edge or cusp, encourages a standing vortex, which advantageously creates a virtual surface of continuity between the storage container and the handlebars. For example, the use of a trip edge at the training edge of the containment unit promotes a favorable pressure gradient that acts as the extension of the container, further integrating it with the handlebar system. Similarly, the s cusp shape can be used like a flow trip to promote flow reattachment in a favorable pressure gradient, which will make the container less sensitive to changes in handlebar diameters or changes in wind conditions with varied levels of turbulence.

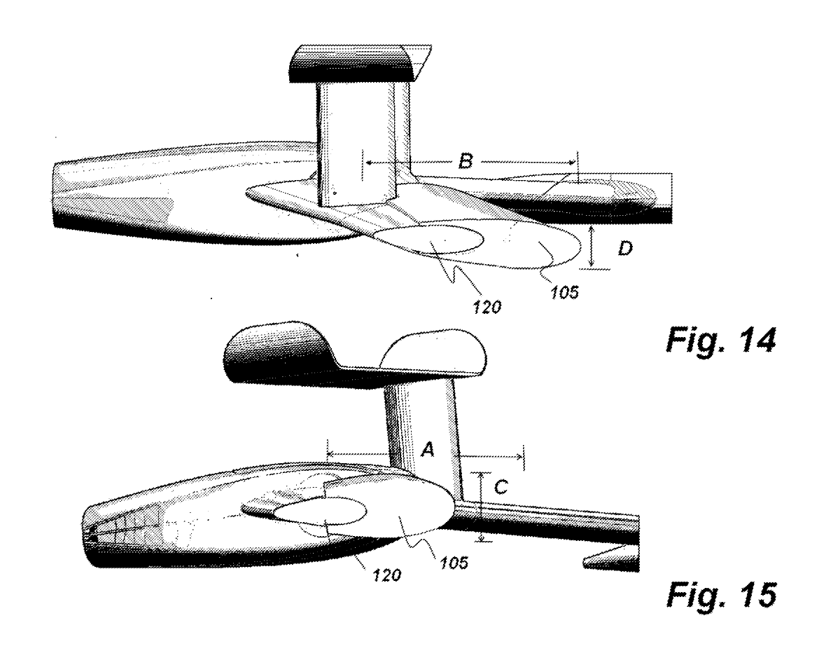

In other words, by making forming a trip edge or cusp at the trailing or other desired section of the containment unit, a trip flow causes a circulation or vortex in the area of discontinuity, which forms a smoother virtual surface for the flow field. This generates a low pressure, which will help flow attachment and reduce drag. Further, the virtual profiled integrated storage container and handlebar system helps control flow without the necessity of designed integration and manufacturing of either the storage container with the handlebar unit, or vise versa. In other words, the ability to provide a virtual or seamless integration of the storage container and handlebars enhances the desirability of the use of described embodiments of the present without regard to the type of handlebar system used. As such, example embodiments contemplate using any standard form of handlebars, e.g., those shown in FIG. 13. More generally, example embodiments also consider the ability to provide a range of integrated units from universal systems (e.g., where one storage container can easily integrate with multiple handlebars, or vise versa) to highly specialized units (e.g., where the container is manufactured as a single unit within the handlebars, as described in more detail below with regards to other example embodiments.

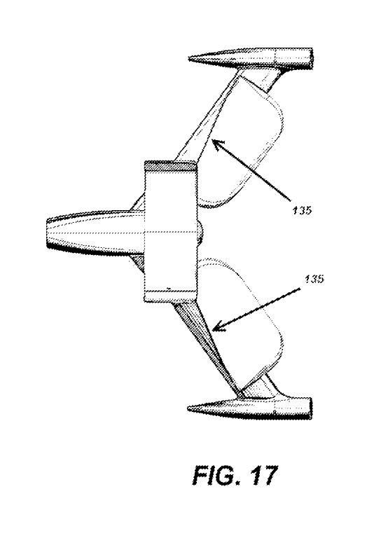

Other embodiments also consider other design factors in optimizing performance with UCI and non-UCI regulations. For example, as shown in FIGS. 16 and 17, the trailing edge 135 of the storage container 105 is slanted or tapered relative to the inside (gooseneck side) to outside (handlebar grip side) edges of the container. This may provide various advantageous including a more aerodynamic design, stability in holding the storage container 105 in place, or even merely for aesthetic purposes. Of course, other similar design considerations and varying shapes and edge forms are considered herein. For example, the storage containers may take almost any form that allows for ease in integration with the handlebar system. As such, any specific shape, size, form or other physical feature of the storage containment unit and integration system as described herein is for illustrative purposes only and is not meant to limit or otherwise narrow the scope of the present invention unless otherwise explicitly claimed.

Without regard to other design considerations noted herein, other example embodiments provide for various forms of attachment mechanisms for securing the storage container 105 to the handlebar 120 system. Although example embodiments generally consider attachment types for easy removal and reattachment of the storage container 105 to the handlebar system 120, other example embodiments allow for more tightly affix the container to the handlebar unit.

For example, as shown in FIGS. 1 and 10, when the containers use a straw or other suction device for extraction of the contents, ease in removal of the containment units may not matter as much as a desire to minimize the overall movement. In such instances, example embodiments consider more stable attachment mechanism, which usually do not allow for ease or quick removal. Such attachment mechanisms may include, without limitation: screws; bolts; pins; clamps; clips; straps; or other similar hardware.

On the other hand, example embodiments also consider the case were frequent removal of the storage container is preferred, which generally means less secure or stable attachment. For instance, if he storage unit are water bottles with flip caps or other opening mechanisms for drinking the contents thereof, then ease in removing (and reattaching) the bottle will generally be desirable. Accordingly, such attachment mechanisms may include, without limitation: magnets; Velcro; clips; snaps; grooved guides or channels; adhesive tape or glue; prongs; or other hardware. Of course, any combination of the attachment mechanisms is also contemplated herein.

In yet another example embodiment, the storage container may be adjustable relative to the handlebar unit in order to divert airflow as desired. For example, the storage container 105 may be fitted at an angle to allow airflow around the handlebar unit. In such embodiment, the rotation of the storage unit provides essentially a turning vane to move the flow of air towards or away from a rider or other parts of the cycling unit. Such airfoil adjustment allows for the reduction of the overall system drag or may serve to simply provide a rider with additional air-cooling when needed.

Still other example embodiment provide for the integration of the attachment mechanism with the storage container, handlebar system, or both. For example, as illustrated in FIG. 9, the cusp shape area that joins or abuts the storage container with the handlebars may include a clamping feature, not shown, that snaps the water bottle or fuel container to the bars. Further, such mechanism may be integrated within the molding or manufacturing operation of the storage container, the handlebars, or both. Further, other embodiments consider the use of molding and or hardware combinations that secure the storage containers onto the handlebar unit. Of course, the attachment mechanism can also be partially or fully machined into the integrated system, e.g., pegs on the storage container that fit into holes drilled into the handlebar units. In addition, as mentioned above, the shape of the bottle itself or other external hardware or integrated pieces may also aid in the attachment and stability of the storage container into the handlebar system. For example, as shown in FIGS. 16 and 17, the added length of the storage container unit as it extends onto the handle bar system may be used in aiding the rotational stability of the storage unit—especially for higher aspect ratios that will cause added potential energy or force in the rotational direction of the container around the handlebars. Of course, other hardware and formed features for assisting in the stability and ease in removal (and attachment) of the water bottle to the handlebar system are also contemplated herein; and therefore, any specific use of attachment mechanism, design shape, or hardware mechanism in describing such embodiments is used herein for illustrative purpose only and is not meant to limit or otherwise narrow the scope of the present invention unless otherwise explicitly claimed.

Note that many types of materials and combinations thereof are considered in forming the integrated storage container and handlebar system herein described. For example, the storage container may be made from polyurethane or other plastic materials, fiberglass material, metals and alloys, carbon fiber, or any other suitable material and combinations thereof. Further, the materials may be of a disposable form for a single use, or a more durable, long lasting material. Of course, the above gives a brief example of the many types of materials used in forming example embodiments described herein; and therefore, it is not meant to limit or otherwise narrow the scope of the present invention unless otherwise specifically claimed.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An integrated handlebar and storage container comprising:
a handlebar unit used in steering a cycling device; and
a storage container integrated with the handlebar unit for storing liquid or solid contents.

2. The integrated handlebar and storage container of claim 1, wherein the storage container attaches to the exterior portion of the handlebar unit.

3. The integrated handlebar and storage container of claim 1, wherein the storage container is internal to the handlebar unit.

4. The integrated handlebar and storage container of claim 3, wherein the storage container includes a malleable bladder type material for ease in integrating within the handlebar unit.

5. The integrated handlebar and storage container of claim 4, wherein the malleable bladder type material comprises one or more of rubber, plastic, cloth, paper, or organic material.

6. The integrated handlebar and storage container of claim 3, wherein the storage container is accessible within the handlebar unit by a lid in the handlebar unit.

7. The integrated handlebar and storage container of claim 3, wherein the storage container is accessible within the handlebar unit by a detachable intersection piece of the handlebar unit.

8. The integrated handlebar and storage container of claim 1, wherein the storage container includes a syphoning device for extracting the contents thereof for human consumption.

9. The integrated handlebar and storage container of claim 1, wherein the storage container forms an aerodynamic shape when integrated with the handlebar unit.

10. The integrated handlebar and storage container of claim 9, wherein the integration of storage container and the handlebar unit forms a 3:1 ratio of length to width for the aerodynamic shape.

11. The integrated handlebar and storage container of claim 9, wherein the integration of storage container and the handlebar unit allows the movement of the storage container to act as a turning vane to move the flow of air toward or away from a rider of the cycling device.

12. The integrated handlebar and storage container of claim 1, wherein the storage container forms a generally round shape of traditional water bottles.

13. The integrated handlebar and storage container of claim 1, wherein the storage container includes a syphoning device for extracting the contents thereof for human consumption.

14. The integrated handlebar and storage container of claim 1, wherein the handlebar unit includes
a stem for connecting the handlebar unit to a bicycle, a pair of handlebars extending in an opposing manner from the stem, and
each of the handlebars having a grip member at an end opposite where the handlebar connects to the stem, the grip member extending in a transverse manner relative to the handlebar, wherein both ends of the grip member extend from the handlebar.

15. The integrated handlebar and storage container of claim 14, wherein the handlebars are forward swept relative to the stem.

16. A handlebar system, comprising:
a handlebar unit including
a stem for connecting the handlebar unit to a bicycle,
a pair of handlebars extending in an opposing manner from the stem, and
each of the handlebars having a grip member at an end opposite where the handlebar connects to the stem, the grip member extending in a transverse manner relative to the handlebar, wherein both ends of the grip member extend from the handlebar.

17. The handlebar system of claim 16, further comprising:
a storage container defining a groove in which at least one of the handlebars is received.

18. The handlebar system of claim 17, wherein the storage container and handlebar unit form a 3:1 ratio of length to width to form an aerodynamic shape.

19. The handlebar system of claim 16, wherein the handlebars are forward swept relative to the stem.

20. The handlebar system of claim 16, wherein the handlebar unit further includes a handlebar extension for receiving at least one of elbows or forearms of a rider.
